(19) United States
(12) Patent Application Publication
(10) Pub. No.: US 2007/0085832 A1
(43) Pub. Date: Apr. 19, 2007

(54) Reducing dust contamination in optical mice

(76) Inventors: John P. Ertel, Half Moon Bay, CA (US); S. Jeffrey Rosner, Palo Alto, CA (US)

Correspondence Address: AVAGO TECHNOLOGIES, LTD., P.O. BOX 1920, DENVER, CO, 80201-1920, US

(21) Appl. No.: 11/252,464

(22) Filed: Oct. 17, 2005

(51) Int. Cl. G09G 5/08

(52) U.S. Cl. 345/166

(57) ABSTRACT

Reduction of dust contamination in optical mice. Operation of the mouse is adapted to direct air past optical surfaces, removing accumulated contaminants. In one aspect, lifting and resetting the mouse directs air through a funnel-like opening to a duct at the side of the optical surface. In a second aspect, mouse button motion is coupled to displace air past optical surfaces.

### TECHNICAL FIELD

Embodiments in accordance with the invention are related to optical mice, and methods of reducing dust contamination in optical mice.

### BACKGROUND

The computer mouse used for navigation on personal computers has evolved significantly since its invention by Douglas Engelbart, as shown in his U.S. Pat. No. 3,541,541.

The modern computer mouse is not mechanical, but optical. An early optical mouse is described in U.S. Pat. No. 6,433,780 by Gordon et al, incorporated herein by reference. An optical mouse has a motion sensor with a light source which illuminates the surface the mouse rests upon. Optical elements focus an image of this surface on an image sensor. Processing electronics connected to the image sensor sense motion by correlating successive images from the image sensor, performing a correlation of successive images with different offsets in X and Y directions, and finding the maximum of the correlation surface.

Dust contamination of the optical elements reduces the effectiveness of the optical mouse by creating a fixed pattern in sensed images. While this is less of a problem with mice which use conventional imaging, since such dust is out of the focal plane, it is of particular concern in optical mice using interference imaging, such as described in U.S. Pat. No. 6,707,027 and 6,872,931 to Liess et al. The fixed pattern created by dust detracts from the variable signals associated with optical navigation, particularly in mice using interference imaging.

### SUMMARY OF THE INVENTION

Dust contamination on the optical surfaces of optical mice is reduced by translating mouse motion and operation into the movement of air across optical surfaces. Lifting and resetting the mouse directs air through a funnel-like capture area and across optical surfaces. Button motion may be engaged to direct air across optical surfaces.

### BRIEF DESCRIPTION OF THE DRAWINGS

FIG. 1 shows a view of an optical mouse known to the art,

FIG. 2 shows a view of a first mouse according to the invention, and

FIG. 3 shows a view of a second mouse according to the invention.

### DETAILED DESCRIPTION OF THE EMBODIMENTS

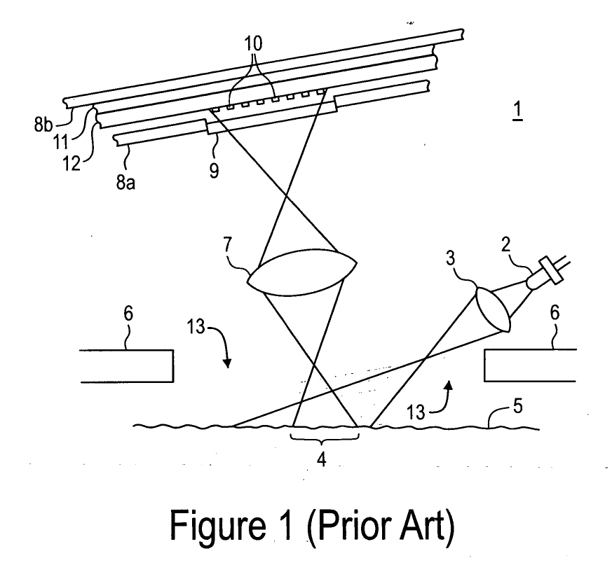

FIG. 1 shows a cut-away side-view of an optical mouse 1 known to the art. Light source 2 emits light which is projected by lens 3 (which may be separate as shown, or may be integrated into the package of source 2), through orifice 13 in bottom surface 6 and onto a region 4 that is part of a work surface 5. Although omitted for clarity, orifice 13 might include a window transparent to the light from source 2, and which serves to keep dust, dirt, or other contamination out of the innards of mouse 1. Light from the illuminated region 4 illuminates photodetector array 10 through window 9 and lens 7. Integrated circuit package portion 8a may dispense with separate window 9 and lens 7 by combining them into one and the same element. Photodetector array 10 is fabricated onto a portion of an integrated circuit die 12 affixed by adhesive 11 or other means to package portion 8b. Photodetector array 10 sends image data to a processor, not shown for purposes of clarity.

While FIG. 1 shows the optical navigation components of the mouse as separate elements, they may also be integrated into a single unit. Such optical navigation assemblies are produced by companies such as Agilent Technologies, Inc, and Philips Electronics N.V.

Dust contamination on optical surfaces reduces the effectiveness of optical navigation sensors.

While dust contamination could be addressed by including a small electric fan inside the mouse, such a solution increases power consumption and noise, even if the fan was only operated intermittently.

According to the present invention, the use and operation of the mouse is adapted to displace air over optical surfaces, reducing debris present on optical surfaces.

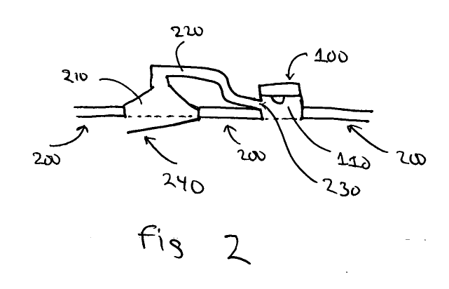

In normal mouse operation, it is common for the user to lift the mouse slightly and reposition it. In a first embodiment of the invention as shown in the cutaway drawing of FIG. 2, this lifting and resetting motion is used to funnel air past optical surfaces. Optical navigation sensor 100 with optical surface 110 may be mounted to mouse base 200, or to a subassembly which is mounted to base 200. Air capture funnel 210 is present as an opening in base 200. Air captured by funnel 210 as the mouse is lifted and resettled on a surface (not shown) is directed through plenum 220 and orifice 230, flowing across optical surface 110 of optical navigation sensor 100. It may be advantageous to include a one-way valve such as flap-valve 240 to further capture and pump air into funnel 210 and orifice 230 as the mouse is lifted and reset on the operating surface. Other moving elements driven by physical motion or operation of the mouse may also captured and used to pump air through orifice 230 as the mouse is used.

In practice, funnel 210, plenum 220, and orifice 230 may be fashioned into base 200, as an example by molding. Funnel 210, plenum 220, and orifice 230 may be a separate assembly attached to base 200. Plenum 220 may be a piece of flexible tubing. If flap valve 240 is included, it may be made as an integral part of base 200 by using flexure techniques.

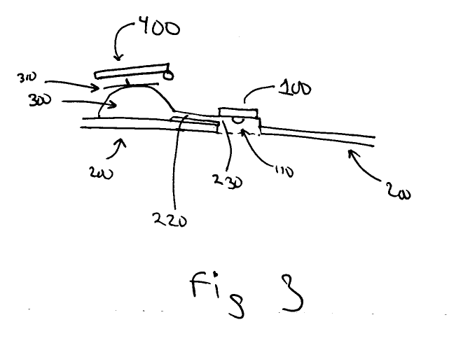

FIG. 3 is a cutaway drawing showing a second embodiment of the invention. Optical navigation sensor 100 with optical element 110 is mounted to mouse base 200. Bellows 300 connects to plenum 220 and orifice 230. Motion of mouse button 400 moves plate 310 against bellows 300, displacing air over optical element 110. In practice, one or more mouse buttons may engage bellows 300 through one or more plates 310, or may engage the bellows directly.

While the embodiments of the present invention have been illustrated in detail, it should be apparent that modifications and adaptations to these embodiments may occur to one skilled in the art without departing from the scope of the present invention as set forth in the following claims.

1. An optical mouse comprising:
a base plate,
an optical navigation sensor including an optical element, the optical navigation sensor mounted to the base plate,
an orifice proximal to the optical element,
a plenum connected to the orifice, and
air directing means for converting mouse operation into air flow through the plenum to the orifice and across the optical element.

2. The optical mouse of claim 1 where the air directing means comprises an opening in the base plate funneling air to the plenum, responsive to lifting and repositioning the mouse.

3. The optical mouse of claim 2 where the air directing means further comprises a flap valve mounted to the opening in the base plate.

4. The optical mouse of claim 1 where the air directing means further comprises pumping means, the pumping means responsive to motion of one or more mouse buttons, forcing air through the plenum to the orifice and across the optical element.

5. The optical mouse of claim 4 where the pumping means comprises a bellows.

6. A method of operating an optical mouse having an optical navigation sensor including an optical element wherein normal mouse operation is adapted to direct air across the optical element.

7. The method of claim 6 wherein the method of operation uses mouse button motion to direct air across the optical element.

8. The method of claim 7 wherein the method of operation uses a bellows operated by mouse button motion to direct air across the optical element.

9. The method of claim 6 wherein the method of operation uses lifting and repositioning of the mouse to direct air across the optical element.
